(19) United States
(12) Patent Application Publication
(10) Pub. No.: US 2011/0166915 A1
(43) Pub. Date: Jul. 7, 2011

(54) SYSTEM AND METHOD FOR DETERMINING A CUSTOMER CONTACT STRATEGY

(76) Inventors: Xianghong S. Wang, Westford, MA (US); Philip L. Hussey, Carlisle, MA (US)

(21) Appl. No.: 12/900,219

(22) Filed: Oct. 7, 2010

Related U.S. Application Data
(60) Provisional application No. 61/249,514, filed on Oct. 7, 2009.

(51) Int. Cl. G06Q 30/00

(52) U.S. Cl. 705/14.4

(57) ABSTRACT

A system and method determines a customer contact strategy that creates associations between customer characteristics and customer responsiveness to direct email campaigns. A plurality of variables relating to historical customer purchasing behavior, and customer responsiveness to direct mail campaigns, are evaluated. In addition, customer responsiveness to direct email campaigns are also evaluated, while also enabling the evaluation of a customer based on customer characteristics and responsiveness. Conventional direct mail campaigns utilize various models to identify customer propensity and prospective customer propensity. The present invention adds to these models a model to determine how well a customer responds to direct email campaigns, and then determines which form of direct contact is preferred at a customer level (i.e., on a customer by customer basis).

### RELATED APPLICATION

This application claims priority to, and the benefit of, co-pending U.S. Provisional Application No. 61/249,514, filed Oct. 7, 2009, for all subject matter common to both applications. The disclosure of said provisional application is hereby incorporated by reference in its entirety.

### FIELD OF THE INVENTION

The present invention relates to a system and method suitable for determining a customer contact strategy as it relates to marketing campaigns, and more particularly to a system and method for ranking customers based on historical customer characteristics and historical email handling behavior.

### BACKGROUND OF THE INVENTION

One form of direct marketing of products and services is referred to as direct mail. Direct mail is a process used by marketing and advertising personnel who send paper mail and sometimes free giveaway items directly to customers or prospective customers using the postal service in an overall effort to increase sales. In fact, any low cost item that can be delivered by the postal service can be used in a direct mail campaign for delivery to an existing or prospective customer. Some representative items include advertising circulars, brochures, catalogs, CD-ROMs, product samples, and the like.

Mass-marketing or advertising on much of the media available today, including television, print media, radio, and the like, can be expensive. However, a direct mail campaign provides businesses with the ability to target a specific, identifiable, group of individuals who are more likely to respond to offers from companies they have had a purchasing relationship with, or individuals fitting certain criterion making them more likely to be interested in purchasing a particular product or service. This can be done at lower cost to the company relative to the other mass-marketing or advertising methods.

More recently, direct mail campaigns have additionally been executed using electronic mail, or email. Because email is relatively inexpensive in comparison with traditional direct mail campaigns, email campaigns have been viewed as a low cost additive method for reaching out to large quantities of customers and potential customers. As a result, it has quickly become conventional to blast emails out to large quantities of email addresses without much attention paid to the effectiveness of such email blast campaigns.

### SUMMARY OF THE INVENTION

There is a need for a system and method that establishes a relationship between individual customer characteristics, responsiveness of individual customers to traditional direct mail campaigns, and responsiveness of individual customers to direct email campaigns. The present invention is directed toward further solutions to address this need, in addition to having other desirable characteristics.

In accordance with one example embodiment of the present invention, a computer-implemented system and method determine a customer contact strategy. Each customer of a plurality of customers is associated with one of a plurality of direct email behavior descriptor segments from a more preferable segment to a less preferable segment based on each customer's historical direct email handling behavior to form customer behavior descriptor segment associations. Each customer of the plurality of customers is associated with one of a plurality of customer characteristics tiers from a more preferable tier to a less preferable tier to form customer characteristic tier associations. The customer behavior descriptor segment associations and the customer characteristic tier associations are transformed into the customer contact strategy by assigning and indicating a preferred contact method of direct mail, electronic mail, or both, for each customer based on the direct email descriptor segment and the tier associated with each customer of the plurality of customers.

In accordance with aspects of the present invention, the plurality of behavior descriptor segments can include a clicker segment, a browser segment, a new customer segment, and an ignorer segment. The step of associating each customer of the plurality of customers with one of a plurality of customer characteristics tiers from a more preferable tier to a less preferable tier can include analyzing historical customer behavior and, based on selected criteria, assigning different ranking values to each customer based on the historical customer behavior. The step of associating each customer of the plurality of customers with one of a plurality of customer characteristics tiers from a more preferable tier to a less preferable tier can include analyzing one or more of customer spending over a predetermined period of time, length of time between customer transactions, length of time since most recent customer transaction, and the like. The step of assigning a preferred contact method of direct mail, electronic mail, or both, to each customer based on the descriptor segment and the tier associated with each customer of the plurality of customers can include assigning a method of direct mail for each customer having a more preferable tier of customer characteristics and a less preferable segment based on email handling. The step of assigning a preferred contact method of direct mail, electronic mail, or both, to each customer based on the descriptor segment and the tier associated with each customer of the plurality of customers can include assigning a method of direct email for each customer having a more preferable segment based on email handling.

In accordance with further aspects of the present invention, the customer characteristics tiers can be assigned based at least in part on a customer responsiveness to direct mail campaigns. The method can further include automating data updates to the customer characteristics relating to electronic interactions by the customer to occur at a desired frequency. The method can further include automating data updates to the customer responsiveness to direct email to occur at a desired frequency. Updates to the historical direct email handling behavior of a customer can be executed at a desired frequency up to a plurality of updates per day.

In accordance with one example embodiment of the present invention, a medium holding instructions executable in a computing device for determining a customer contact strategy can be provided. The instructions can be directed to a computer-implemented method, wherein each customer of a plurality of customers is associated with one of a plurality of direct email behavior descriptor segments from a more preferable segment to a less preferable segment based on each customer's historical direct email handling behavior to form customer behavior descriptor segment associations. Each customer of the plurality of customers is associated with one of a plurality of customer characteristics tiers from a more preferable tier to a less preferable tier to form customer characteristic tier associations. The customer behavior descriptor segment associations and the customer characteristic tier associations are transformed into the customer contact strategy by assigning and indicating a preferred contact method of direct mail, electronic mail, or both, for each customer based on the direct email descriptor segment and the tier associated with each customer of the plurality of customers.

In accordance with one example embodiment of the present invention, a system for determining a customer contact strategy includes a plurality of customer behavior descriptor segment associations resulting from an association of each customer of a plurality of customers with one of a plurality of direct email behavior descriptor segments from a more preferable segment to a less preferable segment based on each customer's historical direct email handling behavior. A plurality of customer characteristic tier associations resulting from an association of each customer of the plurality of customers with one of a plurality of customer characteristics tiers from a more preferable tier to a less preferable tier. A processor configured in such a way so as to operate to transform the plurality of customer behavior descriptor segment associations and the plurality of customer characteristic tier associations into the customer contact strategy by assigning a preferred contact method of direct mail, electronic mail, or both, to each customer based on the direct email descriptor segment and the tier associated with each customer of the plurality of customers.

### BRIEF DESCRIPTION OF THE DRAWINGS

The present invention will become better understood with reference to the following description and accompanying drawings, wherein:

FIG. 1 is a diagrammatic representation of two factors considered when determining a customer contact strategy, according to one aspect of the present invention;

FIG. 2 is a diagrammatic representation of segments resulting from an analysis of customer responsiveness to direct email, according to one aspect of the present invention;

FIG. 3 is a flowchart illustrating steps utilized in determining a contact strategy, according to one embodiment of the present invention; and

FIG. 4 is a diagrammatic illustration of a computing environment suitable for implementing the method(s) of the present invention.

### DETAILED DESCRIPTION

An illustrative embodiment of the present invention relates to system and method for determining a customer contact strategy that creates associations between customer characteristics and customer responsiveness to direct email campaigns. More specifically, the present invention evaluates a plurality of variables relating to historical customer purchasing behavior, and customer responsiveness to direct mail campaigns, and additionally evaluates customer responsiveness to direct email campaigns, while also enabling the evaluation of a customer based on customer characteristics and responsiveness. Conventional direct mail campaigns utilize various models to identify customer propensity and prospective customer propensity. The present invention adds to these models a model to determine how well a customer responds to direct email campaigns, and then determines which form of direct contact is preferred at a customer level (i.e., on a customer by customer basis).

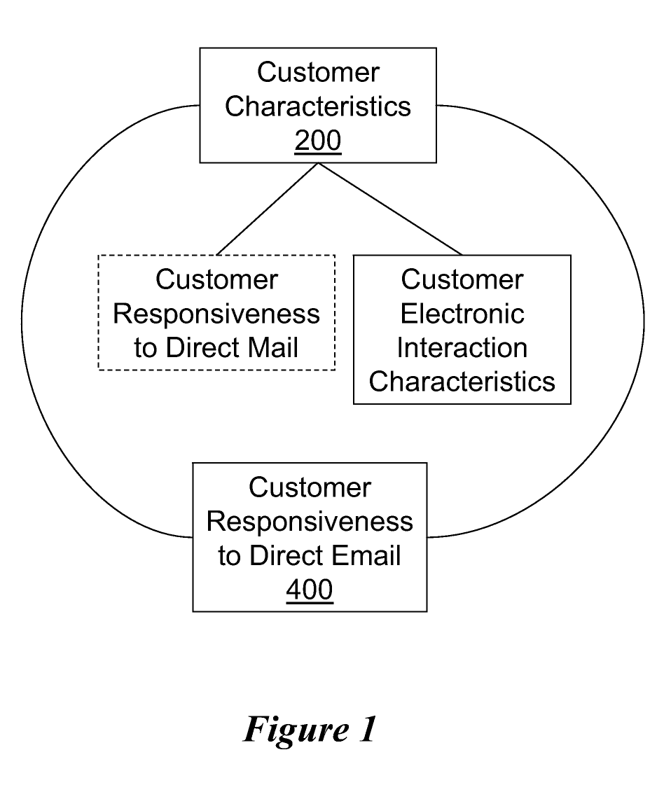

FIGS. 1 through 4, wherein like parts are designated by like reference numerals throughout, illustrate an example embodiment of a system and method for determining a customer contact strategy according to the present invention. Although the present invention will be described with reference to the example embodiment illustrated in the figures, it should be understood that many alternative forms can embody the present invention. One of ordinary skill in the art will additionally appreciate different ways to alter the parameters of the embodiments disclosed in a manner still in keeping with the spirit and scope of the present invention.

Conventional direct mail campaigns place substantial emphasis on mailing list hygiene. Specifically, there are a number of services available to a direct mail marketer or advertiser to help to improve the quality of their mailing lists. Some example services include: intelligent mail bar coding, which electronically tracks mail; national change of address updates; United States Postal Service (USPS) CASS™ Certification, which is a USPS service that improves the accuracy of carrier route, five-digit ZIP®, ZIP+4®, and delivery point codes that appear on mail pieces; address standardization, which takes address entries and ensures they are formatted and expressed in their official form as recognized by the USPS; postal pre-sorting, which sorts bulk mailings to the degree required by the USPS bulk mailing requirements; and delivery point validation, which through various mechanisms can validate that a mailing address is accurate and valid.

The present invention can operate in conjunction with the above-noted services, but adds another dimension to the factors considered when designing an overall customer contact strategy. That additional dimension is an evaluation of the customer responsiveness to direct email campaigns, in conjunction with and in view of selected customer characteristics, and development of a customer contact strategy based on these evaluations.

As mentioned previously, postal services (including the United States Postal Service) often offer special rate, or bulk mail, pricing, with different per-mail-piece pricing depending on quantities and amount of up front preparation work performed. The phrase “bulk mail” as utilized herein is intended to include any USPS special rate pricing for bulk mail, as well as equivalents thereto in other countries. The up front preparation work required for bulk mail pricing includes, for example, such activities as pre-sorting the mail by ZIP Code, depositing the mail at a certain postal service location, or formatting the mailing label to comply with certain postal service guidelines. This preparation enables the mail to be processed more quickly and efficiently by the postal service, thereby reducing the handling costs of the postal service. Accordingly, the postal service passes on those savings to the customer with the various bulk mailing rates and categories.

However, even with these reduced mailing rates, direct mail marketers and advertisers often seek to refine their mailing lists of existing and prospective customers such that mail is only sent to households where it will have the most advertising or marketing impact. Some mailing lists are pulled from databases after extensive analysis to find those recipients that are considered most likely to respond positively to the direct mailing. A simple example of this would be an individual who has demonstrated an interest in golf in a particular database may receive direct mail advertising golf related publications, goods, or services.

In addition to mailing list hygiene, some marketing strategies consider the effectiveness of their direct mail campaigns. Various analysis and evaluations of direct mail campaigns are implemented to assess whether a direct mail campaign had any positive result on sales.

The present invention leverages two primary factors to arrive at a customer contact strategy, as shown in FIG. 1. Those two primary factors are customer characteristics 200, which is determined by the utilization of existing or newly developed variables or models to identify customer characteristics and attributes optionally including a customer responsiveness to direct mail, which is determined by the utilization of existing or newly developed variables or models to identify how individual customers respond to implementations of direct mail campaigns (i.e., did the direct mail campaign effect a change in the customer's subsequent purchases?); and a customer responsiveness to direct email 400, which as described herein relates to an evaluation of how individual customers respond to implementations of direct email campaigns.

The customer characteristics 200 can be determined a number of different ways, using a number of different models and approaches, as would be understood by those of ordinary skill in the art. Specific metrics are gathered and recorded relating to individual customers correlated with their household addresses. In some instances, extensive efforts are made to obtain customer characteristics (e.g., gender, income, historical purchasing patterns, group memberships, hobbies, interests, age, etc.) and then evaluate those characteristics to assign values or labels to individual customers indicating how they should be treated within a particular direct mail campaign strategy. The main types of characteristics conventionally sought after fall under the broad categories of demographics, psychographics, and purchase history. All such characteristics, and any equivalents, may be utilized in conjunction with the present invention.

Customer characteristics 200 can additionally include a metric of customer propensity. By “customer propensity” what is meant is the propensity of an identified previous customer of a particular seller to make another purchase in the future, based in part on an analysis of past purchase performance. For example, the customer propensity can be determined by assessing a recency of prior purchases by a customer at a household from the particular seller for which the analysis is undertaken. The customer propensity can be determined by a total dollar amount of spending by a household at the particular seller over the course of a year, or perhaps over a lifetime. Customer propensity can be determined by additional factors and characteristics, and can likewise be determined by a combination of any of the above as well.

Furthermore, customer characteristics 200 can additionally include a prospective customer propensity, which can likewise be determined a number of different ways, using a number of different models and approaches, as would be understood by those of ordinary skill in the art. By “prospective customer propensity” what is meant is the propensity of a non-customer meeting certain criteria giving them a likelihood of being a future customer of a particular seller and to make a first purchase in the future, based in part on an analysis of various criteria. For example, the prospective customer propensity can be determined by assessing such characteristics as type of household, geographical location of household, average income of neighborhood and/or household, education level of household, and many other characteristics as are conventionally reviewed when trying to identify prospective customers. Prospective customer propensity can be determined by additional factors and characteristics, and can likewise be determined by a combination of any of the above as well.

To contact customers in direct mail campaigns, one must have a household address associated with each customer. As such, the customer characteristics 200 may also include attributes related to the household address. The household address can be a source for making associations with nearby seller location in embodiments where the seller has a physical location or a virtual web presence. Each household address can be assessed for its relative distance (physical or electronic) to the seller. By “electronic distance” what is meant is the relative logistical difficulty one experiences when attempting to shop online (e.g., ability to locate seller online, connectivity capabilities, ease of user interface, etc.).

In addition to all of the above potential customer characteristics 200 a category of customer characteristics may also include a customer's electronic interactions, or interactions with electronic media. For example, a customer's electronic interactions including activity on the Internet with blogs, uploads, downloads, visits to web pages, voluntary profile submissions, text messaging and other mobile activities, and the like can additionally be recorded and tracked as a part of the customer characteristics 200. Furthermore, and as discussed herein, because the present invention is computer-implemented, updates concerning the customer's activity on the Internet can occur repeatedly and with high frequency, including multiple times per day for each customer. The ability to implement such frequent and repeated updates provides substantially improved and more accurate data concerning the customer characteristics 200 as they relate to electronic interactions.

In addition to all of the above electronic interactions and other characteristics, the customer characteristics 200 can optionally include customer responsiveness to direct mail. This characteristic relates to how a customer responds to particular direct mail campaigns. For example, if a customer receives a direct mailing, does their purchasing profile or characteristic change? Are they more likely to make a purchase from the seller following a direct mail campaign? Does the customer participate in any other activity, such as research, web searching, calls to toll free numbers, or other traceable activity as a result of receiving a piece of direct mail. As with other customer characteristics 200, one of ordinary skill in the art will appreciate that determination of customer responsiveness to direct mail can be implemented using a number of presently conventional practices, and also can include future models not yet conceived of at the time of the present invention. What is relevant to the present invention is that some form of customer responsiveness to direct mail can be recorded and the data can be manipulated using some form of analysis, on a per customer basis.

The customer characteristics 200 as a whole can be ranked from more preferable to less preferable, and can further be grouped in tiers (e.g., a gold level, silver level, bronze level, and coal level). One of ordinary skill in the art will appreciate that determination of customer characteristics can occur using a number of presently conventional practices, and also can include future models not yet conceived of at the time of the present invention. What is relevant to the present invention is that some form of customer characteristics can be determined using some form of analysis, on a per customer basis.

It should be noted that the term “seller” as utilized herein refers to any entity that is trading or selling, including a classically defined retailer, as well as a wholesaler, distributor, re-seller, a person or entity who promotes or exchanges goods or services for money or other goods or services, or the like, such that there is no limitation of the term “seller” as being distinct in any way with regard to its use in conjunction with the present invention.

A customer responsiveness to direct email 400 is a second factor considered in the present system and method. This factor relates to how a customer responds to particular direct email campaigns. For example, if a customer receives a direct emailing, does their purchasing profile or characteristic change? Are they more likely to make a purchase from the seller following a direct email campaign? Does the customer participate in any other activity, such as research, web searching, calls to toll free numbers, or other traceable activity as a result of receiving a piece of direct email?

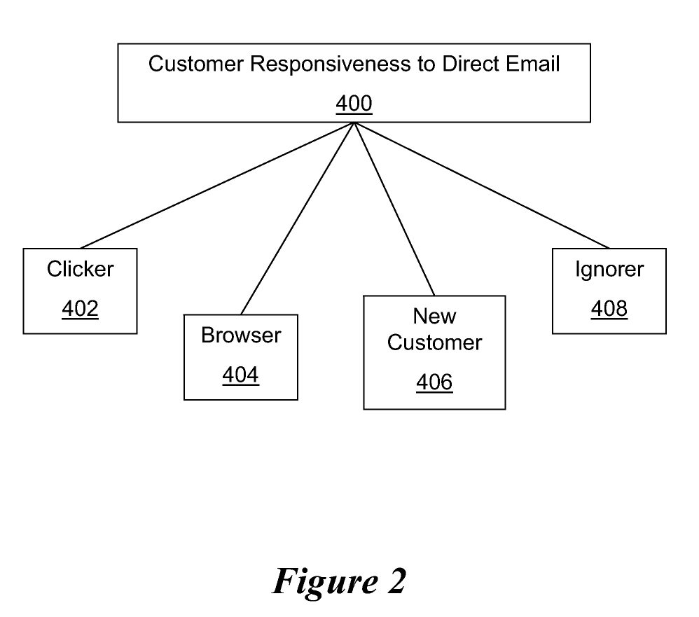

In addition to the above data, there are additional forms of data that can be collected and recorded for later evaluation and analysis with respect to customer responsiveness to direct email 400. Once a direct email is received, the customer has various options as to how they interact with the email and respond. FIG. 2 illustrates some of these options. For example, the response of the customer can be separated into segments, a clicker 402, a browser 404, a new customer 406, and an ignorer 408. One of ordinary skill in the art will appreciate that other segments may be created and considered. The segments described herein are merely illustrative of the present invention in accordance with one example embodiment.

In the context of the present invention, the clicker 402 is defined as a customer who receives a direct email containing one or more hyperlinks to another location. The customer clicks on the one or more hyperlinks and follows them to the other location. A clicker 402 can be further categorized as multi-click, single-click multi-open, or single-click single open.

The browser 404 is defined as a customer who receives a direct email containing one or more hyperlinks to another location. The customer browses the email, but does not click on the one or more hyperlinks. Alternatively, the customer may only partially click through a multi-click link.

The new customer 406 is defined as a new customer that previously had no direct relationship with the particular seller that is the perpetrator of the direct email, or perhaps an individual that has received direct emails but never purchased a product from the seller.

The ignorer 408 is a customer that receives the email but does not open the email. In some instances, emails will include graphics that do not initially come through in the email. A prompt will ask a user to “click to display images”. This action can be traced and it can be determined whether the customer has viewed the email based on whether they have downloaded the images.

Similar to the other electronic interactions, the customer responsiveness to direct email 400 can be measured by the computer-implemented processes of the present invention on a frequent and recurring basis to obtain and record the most up to date information. Measurements of responsiveness can be taken and recorded multiple times per day, if desired.

As with customer responsiveness to direct mail 300, one of ordinary skill in the art will appreciate that customer responsiveness to direct email 400 can be determined using a number of different approaches, such that the present invention is in no way limited to the specific examples provided herein. Similar to customer responsiveness to direct mail 300, an important aspect of the customer responsiveness to direct email 400 is that the response can be recorded and the data can be manipulated using some form of analysis, on a per customer basis.

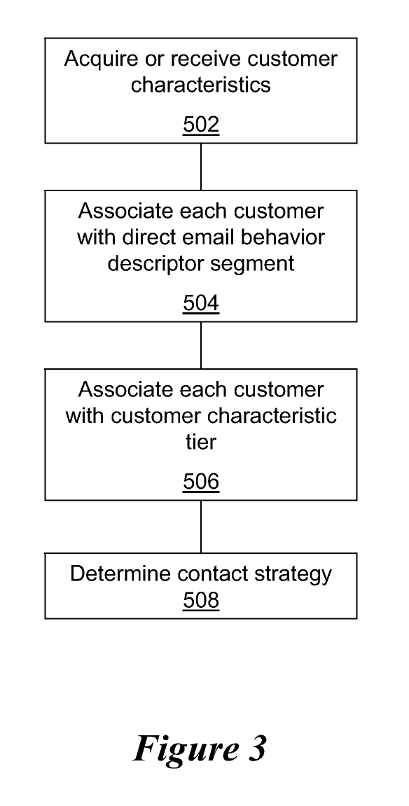

FIG. 3 illustrates an example embodiment of a method for determining a customer contact strategy in accordance with the present invention. The method includes acquiring or receiving customer characteristics (step 502). These customer characteristics 200 can be generated in any number of ways, including those described herein. The method continues with associating each customer contained within the customer characteristics 200 data with a direct email behavior descriptor segment (step 504).

The direct email behavior descriptor segment can be defined using a number of different approaches. One illustrative example is to create the segments as shown in FIG. 2 herein. Accordingly, customers from the customer characteristics 200 data are further associated with a segment of clicker 402, browser 404, new customer 406, or ignorer 408. In the described structure, these segments are in order of more preferred (clicker 402) to less preferred (ignorer 408). Additional segments may be provided.

The method continues with associating each customer with a customer characteristic tier (step 506). As described herein, these can be handled and structured any number of different ways. For purposes of illustration, the present invention can make use of a system rating a customer having more preferred customer characteristics as gold, and a customer having the least preferred customer characteristics as coal. In between gold and coal can be additional tiers of silver and bronze, such that the complete structure of tiers goes from gold to silver to bronze to coal. As one of ordinary skill in the art will appreciate, there are numerous ways to rank customers having different collections of characteristics. All such ways are contemplated for use with the present invention to the extent they can formulate or result in some ordered list of customers based on their customer characteristics. As such, the present invention is by no means limited to the specific structure of tiers described herein.

Taking the direct email behavior descriptor segment associations and the customer characteristic tiers, the system and method of the present invention then determine a contact strategy based on these two factors (step 508).

To elaborate, the contact strategy can be determined, using a microprocessor or other computer device having instructions for parsing and organizing the data and information, to result in an ordered list of recommendations as to how a campaign should target to contact each of the plurality of customers. A contact strategy in accordance with the present invention requires a selection between two different contact methods, e.g., direct mail and direct email. Those customers having relatively higher ranking of customer characteristics will receive direct mail and possibly also direct email. Those customers having relatively lower ranking of customer characteristics will receive direct emailing or no contact, because these are lower cost than direct mailings. Those customers having relatively higher direct email behavior descriptor segment rankings will receive direct emails, while those customers having relatively lower direct email behavior descriptor segment rankings will either not receive direct emails (but may receive direct mail), or will not receive anything.

Table 1 below is a table representative of an optimized customer strategy resulting from the implementation of the present invention (Note: EM means direct email and DM means direct mail).

TABLE 1

| Customer | | | | |
|---|---|---|---|---|
| Characteristics | | | New | |
| Ranking | Clicker | Browser | Customer | Ignorer |
| Gold | EM/DM | DM | DM | DM |
| Silver | EM | EM | DM | DM |
| Bronze | EM | EM | DM | DM |
| Coal | EM | EM | DM | EM |

As can be seen in the table, the upper left-hand section represents the largest number of highest quality customers and prospects, with customer characteristics having the highest ranking, and best response to email, and as such receives both direct email and direct mail campaigns. As the number of high quality customers and prospects decreases, the use of direct mail (the more expensive form of contact) decreases. As the number of high quality customers and prospects that respond well to email decreases, the use of direct mail increases.

Because the present invention is computer-implemented, the accuracy of all data relating to electronic interactions is greatly improved over conventional data mining approaches. Data on customer characteristics 200 and customer responsiveness to direct email 400 that is based on electronic interactions can be updated with high frequency, including multiple times per day. The updates can be automated to run on a desired frequency automatically, or they can be run on a one-time basis. The automation enables one to re-evaluate a customer's behavior before every contact is sent.

The method as described herein is implemented on an electronic computing apparatus to enable accurate and efficient handling of all of the variables and criteria that go into the optimization of the direct mail address list. Embodiments of the present invention can be implemented in the form of computer-implemented processes and apparatuses or systems. In exemplary embodiments, the method of the present invention is embodied in computer program code executable by one or more local or distributed computing apparatuses. Embodiments include computer program code containing instructions embodied in tangible media, diskettes, CD-ROMs, hard drives, flash drives, or any other computer-readable storage medium, wherein, when the computer program code is loaded into and executed by an electronic computing apparatus, the electronic computing apparatus becomes an apparatus for practicing the invention. Embodiments include computer program code, for example, whether stored in a storage medium, loaded into and/or executed by an electronic computing apparatus, or transmitted over some transmission medium, such as over electrical wiring or cabling, through fiber optics, or via electromagnetic radiation, or wirelessly, wherein, when the computer program code is loaded into and executed by an electronic computing apparatus, the electronic computing apparatus becomes an apparatus for practicing the invention. When implemented on a general-purpose microprocessor, the computer program code segments configure the microprocessor to create specific logic circuits.

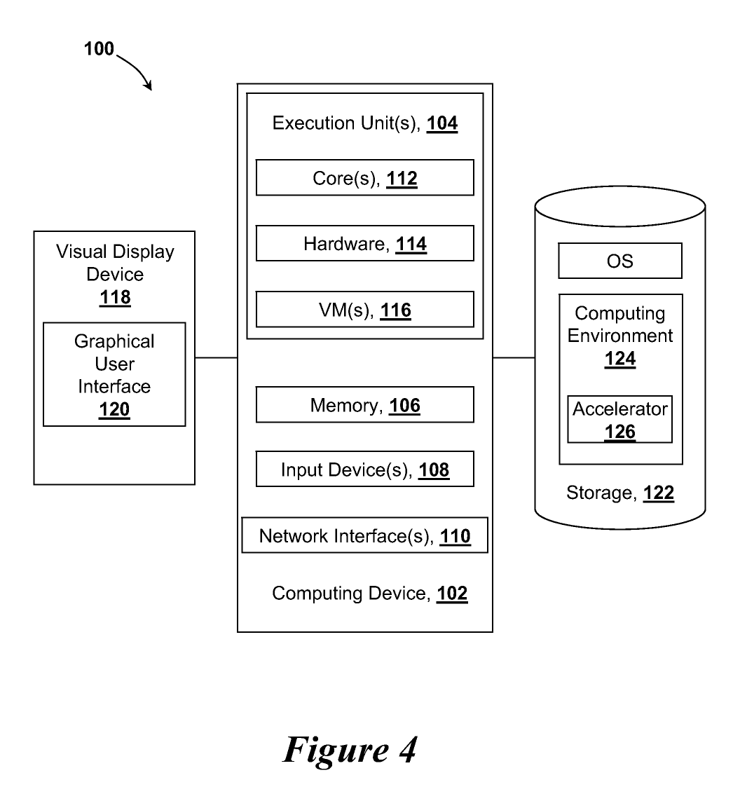

FIG. 4 depicts a computing environment 100 suitable for practicing exemplary embodiments of the present invention. A computing device 102 may include execution units 104, memory 106, input device(s) 108, and network interface(s) 110. The execution units 104 may include hardware or software based logic to execute instructions on behalf of the computing device 102. For example, depending on specific implementation requirements, execution units 104 may include: one or more processors, such as a microprocessor; single or multiple cores 112 for executing software stored in the memory 106, or other programs for controlling the computing device 102; hardware 114, such as a digital signal processor (DSP), a graphics processing unit (GPU), a field programmable gate array (FPGA), an application specific integrated circuit (ASIC), etc., on which at least a part of applications can be executed; and/or a virtual machine (VM) 116 for executing the code loaded in the memory 106 (multiple VMs 116 may be resident on a single execution unit 104).

Depending on specific implementation requirements, the memory 106 may include a computer system memory or random access memory (RAM), such as dynamic RAM (DRAM), static RAM (SRAM), extended data out RAM (EDO RAM), etc. The memory 106 may include other types of memory as well, or combinations thereof. A user may interact with the computing device 102 through a visual display device 118, such as a computer monitor, which may include a graphical user interface (GUI) 120. The computing device 102 may include other I/O devices, such a keyboard, and a pointing device (for example, a mouse) for receiving input from a user. Optionally, the keyboard and the pointing device may be connected to the visual display device 118. The computing device 102 may include other suitable conventional I/O peripherals. Moreover, depending on particular implementation requirements of the present invention, the computing device 102 may be any computer system such as a workstation, desktop computer, server, laptop, handheld computer or other appropriate form of computing or telecommunications device that is capable of communication and that has sufficient processor power and memory capacity to perform the operations described herein.

Additionally, the computing device 102 may include interfaces, such as the network interface 110, to interface to a Local Area Network (LAN), Wide Area Network (WAN), a cellular network, the Internet, or another network, through a variety of connections including, but not limited to, standard telephone lines, LAN or WAN links (e.g., T1, T3, 56 kb, X.25), broadband connections (e.g., integrated services digital network (ISDN), Frame Relay, asynchronous transfer mode (ATM), synchronous transfer mode (STM), wireless connections (e.g., 802.11), high-speed interconnects (e.g., InfiniBand, gigabit Ethernet, Myrinet) or some combination of any or all of the above as appropriate for a particular embodiment of the present invention. The network interface 110 may include a built-in network adapter, network interface card, personal computer memory card international association (PCMCIA) network card, card bus network adapter, wireless network adapter, universal serial bus (USB) network adapter, modem or any other device suitable for interfacing the computing device 102 to any type of network capable of communication and performing the operations described herein.

The computing device 102 may further include a storage device 122, such as a hard-drive, flash-drive, or CD-ROM, for storing an operating system (OS) and for storing application software programs, such as the computing application or environment 124. The computing environment 124 may run on any operating system such as any of the versions of the conventional operating systems, any embedded operating system, any real-time operating system, any open source operating system, any proprietary operating system, any operating systems for mobile computing devices, or any other operating system capable of running on the computing device and performing the operations described herein. Furthermore, the operating system and the computing environment 124 may in some instances be run from a bootable CD. The computing environment 124 may include an accelerator 126 that enables a computing application or computing environment 120 to compute one or more elementwise expressions in parallel.

One of ordinary skill in the art will appreciate that the above description concerning the computing environment 100 is intended to encompass all conventional computing systems suitable for carrying out methods of the present invention. As such, any variations or equivalents thereof that are likewise suitable for carrying out the methods of the present invention are likewise intended to be included in the computing environment 100 described herein. Furthermore, to the extent there are any specific embodiments or variations on the computing environment 100 that are not suitable for, or would make inoperable, the implementation of the present invention, such embodiments or variations are not intended for use with the present invention.

One of ordinary skill in the art will appreciate that the above described example embodiment is merely representative of a process that can be implemented to carry out the present invention. Specific steps described within the method can and may be done in equivalent manner, or in some instances may not be necessary for a particular implementation. As such, the present invention is by no means limited to this specific implementation example.

Numerous modifications and alternative embodiments of the present invention will be apparent to those skilled in the art in view of the foregoing description. Accordingly, this description is to be construed as illustrative only and is for the purpose of teaching those skilled in the art the best mode for carrying out the present invention. Details of the structure may vary substantially without departing from the spirit of the present invention, and exclusive use of all modifications that come within the scope of the appended claims is reserved. It is intended that the present invention be limited only to the extent required by the appended claims and the applicable rules of law.

What is claimed is:

1. A computer-implemented method for determining a customer contact strategy, the method comprising:
associating each customer of a plurality of customers with one of a plurality of direct email behavior descriptor segments from a more preferable segment to a less preferable segment based on each customer's historical direct email handling behavior to form customer behavior descriptor segment associations;
associating each customer of the plurality of customers with one of a plurality of customer characteristics tiers from a more preferable tier to a less preferable tier to form customer characteristic tier associations;
transforming the customer behavior descriptor segment associations and the customer characteristic tier associations into the customer contact strategy by assigning and indicating a preferred contact method of direct mail, electronic mail, or both, for each customer based on each direct email descriptor segment and each tier associated with each customer of the plurality of customers.

2. The method of claim 1, wherein the plurality of direct email behavior descriptor segments comprises a clicker segment, a browser segment, a new customer segment, and an ignorer segment.

3. The method of claim 1, wherein associating each customer of the plurality of customers with one of the plurality of customer characteristics tiers from a more preferable tier to a less preferable tier comprises analyzing historical customer behavior and, based on selected criteria, assigning different ranking values to each customer based on historical customer behavior.

4. The method of claim 1, wherein associating each customer of the plurality of customers with one of the plurality of customer characteristics tiers from a more preferable tier to a less preferable tier comprises analyzing one or more of customer spending over a predetermined period of time, length of time between customer transactions, length of time since most recent customer transaction, and the like.

5. The method of claim 1, wherein assigning a preferred contact method of direct mail, electronic mail, or both, to each customer based on the plurality of direct email behavior descriptor segments and the tier associated with each customer of the plurality of customers comprises assigning a method of direct mail for each customer having a more preferable tier of customer characteristics and a less preferable segment based on email handling.

6. The method of claim 1, wherein assigning a preferred contact method of direct mail, electronic mail, or both, to each customer based on the plurality of direct email behavior descriptor segments and the tier associated with each customer of the plurality of customers comprises assigning a method of direct email for each customer having a more preferable segment based on email handling.

7. The method of claim 1, wherein the customer characteristics tiers are assigned based at least in part on a customer responsiveness to direct mail campaigns.

8. The method of claim 7, further comprising automating data updates to the customer responsiveness to direct email to occur at a desired frequency.

9. The method of claim 1, further comprising automating data updates to the customer characteristics tiers relating to electronic interactions by the customer to occur at a desired frequency.

10. The method of claim 1, wherein updates to the historical direct email handling behavior of a customer are executed at a desired frequency up to a plurality of updates per day.

11. A medium holding instructions executable in a computing device for determining a customer contact strategy, the method comprising the steps of claim 1.

12. A system for determining a customer contact strategy, the system comprising:
a plurality of customer behavior descriptor segment associations resulting from an association of each customer of a plurality of customers with one of a plurality of direct email behavior descriptor segments from a more preferable segment to a less preferable segment based on each customer's historical direct email handling behavior;
a plurality of customer characteristic tier associations resulting from an association of each customer of the plurality of customers with one of a plurality of customer characteristics tiers from a more preferable tier to a less preferable tier; and
a processor configured in such a way so as to operate to transform the plurality of customer behavior descriptor segment associations and the plurality of customer characteristic tier associations into the customer contact strategy by assigning a preferred contact method of direct mail, electronic mail, or both, to each customer based on each direct email descriptor segment and the tier associated with each customer of the plurality of customers.

13. The system of claim 12, wherein the plurality of direct email behavior descriptor segments comprises a clicker segment, a browser segment, a new customer segment, and an ignorer segment.

14. The system of claim 12, wherein assigning a preferred contact method of direct mail, electronic mail, or both, to each customer based on the plurality of direct email behavior descriptor segments and the tier associated with each customer of the plurality of customers comprises assigning a method of direct mail for each customer having a more preferable tier of customer characteristics and a less preferable segment based on email handling.

15. The system of claim 12, wherein assigning a preferred contact method of direct mail, electronic mail, or both, to each customer based on the plurality of direct email behavior descriptor segments and the tier associated with each customer of the plurality of customers comprises assigning a method of direct email for each customer having a more preferable segment based on email handling.

16. The system of claim 12, wherein the customer characteristics tiers are assigned based at least in part on a customer responsiveness to direct mail campaigns.

17. The system of claim 16, further comprising automated data updates to the customer responsiveness to direct email occurring at a desired frequency.

18. The system of claim 12, further comprising automated data updates to the customer characteristics tiers relating to electronic interactions by the customer to occurring at a desired frequency.

19. The system of claim 12, wherein updates to the historical direct email handling behavior of a customer are executed at a desired frequency up to a plurality of updates per day.
